(19) United States
(12) Patent Application Publication
(10) Pub. No.: US 2010/0030587 A1
(43) Pub. Date: Feb. 4, 2010

(54) System and Method for Protection of Assets

(75) Inventor: David C. Holland, Houston, TX (US)

Correspondence Address: PAUL S MADAN;MADAN & SRIRAM, PC, 2603 AUGUSTA DRIVE, SUITE 700, HOUSTON, TX, 77057-5662, US

(73) Assignee: GLOBAL EDGE INSURANCE COMPANY LTD., Tortola (VG)

(21) Appl. No.: 12/566,011

(22) Filed: Sep. 24, 2009

Related U.S. Application Data
(63) Continuation-in-part of application No. 10/164,104, filed on Jun. 5, 2002.

(51) Int. Cl. G06Q 40/00; G06Q 50/00

(52) U.S. Cl. 705/4

(57) ABSTRACT

A novel life insurance policy provides for an increase in the paid up value of the policy upon the policy holder suffering a financial loss. The loss may result from professional liability of the policy holder, including acts of omission or commission, or may results from any type of casualty loss.

### CROSS-REFERENCES TO RELATED APPLICATIONS

This application is a continuation-in-part of U.S. patent application Ser. No. 10/164,104 filed on Jun. 5, 2002, the contents of which are incorporated herein by reference.

### FIELD OF THE DISCLOSURE

This disclosure relates to a system and method for protecting the assets of individuals who have suffered financial loss.

### BACKGROUND OF THE DISCLOSURE

In the insurance world, there are two broad kinds of insurance that require separate licensure. In the United States, one category is life and health insurance, and the other category is property and casualty (P&C). The two basic distinctions are that the former insures physical beings against death and infirmity (albeit with monetary response) and must have renewal guarantees (otherwise, the insurer would simply fail to renew on bad medical news), hence the label “long term.” On the other hand, P&C covers either financial loss to property (e.g., fire, windstorm, and theft) or coverage for liabilities to third parties.

It is worth noting that most of the leading life insurance companies are organized as mutuals, while P&C companies are typically stock companies. P&C companies often do offer life insurance through a subsidiary in order to have a complete product line, but their life insurance products are not competitive for sophisticated buyers. The top five mutual life insurance companies do not offer any kind of P&C products. Most, perhaps all of the states in the US require separate licensing for the sale of the two categories of products.

One product sold by P&C companies is coverage for liability to third parties. A cornerstone of our legal system is that those who cause financial harm to others and are financially held accountable for their actions. Historically, any individual or company that wished to insure against liabilities associated with his trade or business usually purchased or had to purchase liability insurance that provides a pool of funds payable to the injured or aggrieved party. Traditional liability insurance is a contract between the insurer and the insured that is designed to make the injured third-party whole by paying funds to the third-party. The basis of the insurance company's liability is the ultimate legal liability of the insured to the claimant. Traditionally, this type of liability insurance provides coverage to professionals such as physicians, attorneys, accountants, and more recently, corporate officers and directors. This system worked reasonably well until recently.

In recent years, third-parties have made increasing use of the tendency of juries to award giant rewards. Today, for example, a physician cannot carry enough traditional liability insurance to protect his or her personal assets from seizure. A physician with, say $5,000,000 in assets in, say stocks and bonds, might think that $5,000,000 in liability insurance would protect his assets. In reality, if there is a $10,000,000 judgment against the physician, the plaintiff collects $5,000,000 (the limit of liability coverage) from the insurance company and then works to execute the balance of the judgment ($5,000,000) against the physician's personal estate. With awards reaching into the tens or even hundreds of millions of dollars, it is almost impossible for a physician to protect his or her assets from seizure. If anything, the liability insurance coverage only serves as a base for additional claims against assets of physicians—that is, it creates a larger target to aim at.

A direct result of the large liability on the part of physicians is that insurance rates go up. The higher rates, together with a perceived need on the part of physicians to increase the amount of coverage, make it prohibitively expensive for many physicians, such as obstetricians, to practice their specialty. In addition, many of the insurance companies that provide professional liability coverage are no longer providing such coverage at any cost. As reported in the Houston Chronicle May 7, 2002, many physicians in Texas will see their professional liability insurance coverage dropped in the next year. A consequence of this loss of coverage will be their inability to practice medicine at most hospitals since most hospitals require the doctors they allowed to admit patients to carry a minimum level of insurance.

The problem is not limited to physicians. Other professions, such as attorneys and accountants also face rising insurance rates. In addition, as reported in the Houston Chronicle Feb. 12, 2002, insurance costs for corporate executives and directors are also going up.

There is a need for an improved method of protecting assets of individuals and other entities from financial loss. Such a method should preferably provide a disincentive for plaintiffs to claim the assets of high risk individuals above and beyond their basic insurance coverage. The present disclosure satisfies this need.

### SUMMARY OF THE DISCLOSURE

One embodiment of the disclosure is a method for protecting a policy holder from a financial loss suffered by an insured. The method includes verifying occurrence of the financial loss, the financial loss comprising an excess of a value of a ruling against the insured over an amount of coverage provided to the insured by a liability insurance policy; increasing a paid up value of a Life Insurance Policy covering the insured upon verification of the financial loss thereby transforming a liability of the insured into a tangible asset; and notifying the policy holder of the increase in the paid up value.

### DETAILED DESCRIPTION OF THE DISCLOSURE

The present disclosure is a system and a method for protecting assets of an individual or an entity from financial loss. It is based on the principle that in approximately 30 states, including Texas and Florida, certain types of assets are not subject to seizure. These so-called “exempt” assets include the cash value of life insurance policies. The method of the present disclosure is discussed next by using an example.

An individual physician, say Dr. John Doe, would approach an Asset Protection Provider (“APP”) and request protection of his assets. The APP is a representative of an insurance company that issues a Novel Insurance Policy as described below. APP then collects the information that is customarily required to write a traditional life insurance policy, plus additional information such as would be required under a traditional liability insurance policy. This would include his personal data such as name, occupation, financial assets. A background check may optionally be made. In addition, Dr. John Doe would also be asked to provide proof of coverage under a traditional liability insurance policy. This could include providing a copy of the traditional liability insurance policy and sending an inquiry, possibly by electronic means, to the issuer of the traditional liability insurance policy. After underwriting and upon payment of a premium, coverage is provided by an insurance company under the Novel Insurance Policy to Dr. John Doe both for the life of the insured and for the loss of financial assets. Typically, the policy provides for the calculation of the premium for the liability coverage separately from the premium for the life risk. Typically, the payment of a premium provides coverage for a period of one year, although other periods may also be used. The amount of the premium is determined using actuarial methods and depends upon the features selected by the insured.

The coverage under the Novel Insurance Policy includes all of the provisions that are customarily present in a life insurance policy. The Novel Insurance Policy and a conventional life insurance policy both provide a Death Benefit to a named beneficiary (or the estate of the insured) under the policy upon the death of the insured. The death of the insured thus serves as a triggering event that results in payment of the Death Benefit to a beneficiary designated by the policy owner.

Some conventional life insurance policies provide a “cash value”. Such a cash value is provided with whole life policies (the premiums are payable to mortality) and paid up life policies (the death benefit is paid up with anything from a single premium to those with final payments based on number of years or age). The cash value is an amount that may be taken in cash by the insured. If all of the cash value is withdrawn, the policy terminates; otherwise it continues. Most of the time, the cash is taken out of the policy through a loan rather than a withdrawal. In the latter event, 100% of the cash value can be borrowed, and the policy will nevertheless remain in force so long as interest on the loan and premiums are paid. In contracts from the leading companies that have been in force a long time, it may be possible to allow the cash value increases to pay future premiums and interest, and have cash left over which in turn can be withdrawn or borrowed. The Novel Insurance Policy may include such a provision and the premium determined accordingly.

A conventional life insurance policy also typically provides a “Paid Up Value.” This is an amount for which coverage continues for the life of the insured without payment of any additional premiums. The Paid Up Value is typically greater than the Cash Value since the investment value of the Cash Value left in the insurance company's hands provides the cost of the continuing insurance coverage. For reasons to be discussed later, it is unlikely that the policyholder of the Novel Insurance Policy will opt to take out the Cash Value.

A conventional life insurance policy may include a provision for waiver of premium in case of disability of the insured. Different definitions of disability may be included in a conventional life insurance policy for the waiver of premium to be triggered, but all concern a physical disability that would affect employment and thus the ability to continue to make premium payments. When this is triggered, and if the insured has selected the waiver of premium benefit, the insured does not have to pay any more premiums to maintain the policy, including scheduled increases in Cash Value. The Novel Insurance Policy includes a provision for waiver of premiums, but includes a different definition of what comprises disability. This is discussed next.

A point of novelty in the Novel Insurance Policy is the trigger mechanism for the waiver of premiums. Continuing the example of Dr. John Doe, in the unfortunate case when he commits malpractice, he will likely be sued by his patient or representative thereof, referred to as the Plaintiff. The definition of malpractice is not pertinent to an understanding of the present disclosure. When Dr. John Doe is sued, the traditional liability insurance policy that was required as a prerequisite for the Novel Insurance Policy will be the primary coverage for defending him in court. The traditional liability insurance policy provides for costs of legal services and any judgment against Dr. John Doe (up to the amount of coverage under the traditional liability policy). The judgment may be appealed, but at some point for the purposes of this example, it becomes a final judgment. When this happens, the plaintiff will collect from the liability insurance company the amount of the judgment up to the amount of coverage under the traditional liability policy (which may be reduced by the costs of legal defense). If the judgment is not completely satisfied by the traditional liability policy, the Plaintiff may then proceed to seize the personal assets of Dr. John Doe.

The seizure of Dr. John Doe's assets then provides a trigger mechanism for the disability waiver in the Novel Insurance Policy. Under the terms of the Novel Insurance Policy, upon seizure of Dr. Doe's assets, the future payment of the life insurance portion of the premium would be waived, in an amount that would otherwise be required to increase the Cash Value and/or the Paid Up Value of the policy in an amount equal to the value of the assets seized. In this sense, the seizure of Dr. Doe's assets may be viewed as the financial death or disability of Dr. Doe as opposed to physical disability. The amount of the increase may be a fraction of the amount seized, up to an amount equal to the coverage under the Novel insurance policy. The fraction would normally be, but need not necessarily be, less than 100% in order to provide additional disincentive to Dr. Doe from deliberately committing malpractice. An important point about the present disclosure is that the waiver of premium is determined not by a physical disability, but by financial disability resulting from a judgment (or binding arbitration as discussed below). The result is that there is a physical transformation of liabilities of Dr. Doe (the excess of the judgment over the coverage provided by the traditional liability policy) into assets in the form of a paid up cash value of a life insurance policy.

As noted above, the assets of a life insurance policy are exempt from creditor levy in some 30 of the 50 states. In an optional embodiment of the present disclosure, the assets of the policy are in the possession of a company created in a jurisdiction that is more debtor friendly than most states in the US. Any one of several countries, such as the Cayman Islands, the Netherlands Antilles, or some states in the US that have begun to embrace the asset protection principles of such jurisdictions, could be the domicile of the insurance company.

Like a conventional life insurance policy, the Novel Insurance Policy includes a provision for loans to the insured. Such loans may be used by the insured as needed; however, the proceeds of the loans may not be exempt from seizure with a few notable exceptions. Generally speaking, the plaintiff can seize any money borrowed by the insured provided the plaintiff can locate it. One exception, for which there is a provision in the policy, makes it possible for the insured to replace any physical assets that may have been seized. For example, office and medical equipment may be purchased using a loan from the policy in which the offshore company retains a purchase money security interest. Office and medical equipment are only examples of the types of physical assets that may be purchased and are not intended to be a limitation to the disclosure. The physical assets are not exempt from seizure by the plaintiff of his representatives; however, the claim of the plaintiff to the physical assets is subordinate to the claim of offshore company. This effectively deprives the plaintiff of any monetary motivation to attempt to seize the physical assets. This arrangement makes it possible for the insured to become more fully functional with assets that are necessary for providing income.

The present disclosure has been described above using the example of a physician as the insured person. However, other professionals such as attorneys and accountants would also benefit from the disclosure. In addition, corporations could provide their officers and directors with a Novel Insurance Policy as discussed above. It is also possible for others such as building contractors who face potentially large judgments to benefit from the protection provided by the present disclosure. There are certain professions, such as stockbrokers, wherein agreements with potential plaintiffs include provisions for binding arbitration with no recourse to courts. In such cases, instead of a final judgment following a lawsuit, the liability of the insured arises from the binding arbitration. Financial losses arising from such binding arbitration are intended to be within the scope of the present disclosure. In addition, the liability insurance policy need not be limited to a professional liability insurance policy. The method and system of the present disclosure is equally applicable wherein coverage is provided by a casualty insurance policy such as a homeowner's policy, automobile liability policy or even an umbrella policy, as such terms are understood by those of ordinary skill in the art of providing insurance coverage.

The method and system of the present disclosure is also useful for providing coverage for actions other than those resulting from failure to perform under standards of a profession. Such situations may commonly arise in breach of contract lawsuits where in spite of the best efforts to adhere to the requirements of a contract, an individual or an entity may be liable for large damages. The present disclosure provides an arrangement for making the insured whole.

Once the Cash or Paid Up Value of the Novel Insurance Policy has been increased under the terms of the policy, APP or another representative of the offshore company provides the information regarding the increase in paid up value to the insured. The insured can then rest assured that some of his assets have been or will be restored.

It should be noted that the term “insured” in the above refers to Dr. Doe. The term “policyholder” refers to someone who has an insurable interest in the wellbeing of the insured. The policyholder need not be, and frequently is not the same as the insured and may be a family member, business associate, debtor, etc. The death benefit cannot literally go to the insured for because he has to die before the death benefit is payable. However, it can be payable to his estate. This beneficiary designation is rarely used because the only people who gain are the insured's creditors. That is why there is almost always a beneficiary for the death benefit other than the insured. However, the insured may be and often is the policy holder, in which case the insured is entitled to all incidents of ownership in the policy, including the right to withdraw or borrow the Cash Value. Therefore, where tax or creditor protection benefits are of primary importance, the policyholder and the insured may be the same person while another person is the beneficiary.

The foregoing description has been limited to specific embodiments of this disclosure. It will be apparent, however, that variations and modifications may be made to the disclosed embodiments, with the attainment of some or all of the advantages of the disclosure. Therefore, it is the object of the appended claims to cover all such variations and modifications as come within the true spirit and scope of the disclosure.

1. A method for protecting a policy holder from a financial loss suffered by an insured person, the method comprising:
verifying occurrence of the financial loss, the financial loss comprising an excess of a value of a ruling against the insured over an amount of coverage provided to the insured by a liability insurance policy;
increasing a paid up value of a Life Insurance Policy covering the insured upon verification of the financial loss thereby transforming a liability of the insured into a tangible asset;
and
notifying the policy holder of the increase in the paid up value.

2. The method of claim 1 wherein the financial loss occurs directly or indirectly from an act of omission or commission by the insured.

3. The method of claim 2 wherein the financial loss arises from a failure of the insured to adhere to a standard of conduct of practice of a profession of the insured, and at least one of: (I) a result of an arbitration or mediation, and (II) a final judgment in a court of law.

4. The method of claim 3 wherein the insured is at least one of: (A) a physician, (B) an attorney, (C) a director of a corporation, (D) an accountant, and, (E) a construction contractor.

5. The method of claim 2 wherein the financial loss arises from:
(i) a breach of a contract by the insured, and
(ii) at least one of: (I) a result of an arbitration or mediation, and, (II) a final judgment in a court of law.

6. The method of claim 2 wherein the financial loss comprises a casualty loss.

7. The method of claim 1 wherein the liability insurance policy is issued by a party other than the issuer of the Life Insurance Policy.

8. The method of claim 1 further comprising verifying coverage under the liability insurance policy prior to increasing the paid up value of the Life Insurance Policy.

9. The method of claim 1 wherein liability insurance policy provides primary coverage for the insured.

10. The method of claim 1 wherein the increase in the paid up value is a fraction of the excess value of the judgment.

11. The method of claim 10 wherein the fraction is less than 100%.

12. The method of claim 1 wherein the life insurance policy further comprises a provision for waiver of a premium following the financial loss.

13. The method of claim 1 wherein a benefit under the life insurance policy is exempt from seizure in at least one of: (A) one of the states comprising the United States of America, and, (B) the United States of America.

14. The method of claim 1 further comprising making a loan to at least one of: (i) the insured, and (ii) the policy holder from an asset of the life insurance policy.

15. The method of claim 14 wherein proceeds of the loan are used for purchase of physical assets, the method further comprising:
retaining a purchase money security interest in the physical assets.
